(19) United States
(12) Patent Application Publication
(10) Pub. No.: US 2014/0223417 A1
(43) Pub. Date: Aug. 7, 2014

(54) PROGRAM LOGIC FOR SPECIFYING THE REQUIREMENTS PLACED ON A DEVELOPMENT RESULT

(71) Applicant: Florian SCHNITZHOFER, Linz (AT)

(72) Inventor: Florian SCHNITZHOFER, Linz (AT)

(21) Appl. No.: 14/171,930

(22) Filed: Feb. 4, 2014

(30) Foreign Application Priority Data
Feb. 5, 2013 (AT) GM50014/2013

(51) Int. Cl. G06F 9/44

(52) U.S. Cl. CPC G06F 8/73
USPC 717/123

(57) ABSTRACT

The invention relates to a program logic for specifying and documenting requirements placed on a development result, wherein several individual requirements are recorded and stored with their mutual relationships in form of a graph. In order to enable documentation of all requirements placed on a development result with respect to complete content and independent of the user's expert knowledge it is proposed that templates for individual requirements associated with at least one development result are stored, a similarity value between at least one of the already recorded individual requirements and the stored requirement templates is calculated, and requirement templates are provided with a similarity value disposed in a predetermined range for individual requirements to be newly recorded, are adjusted thereto and are stored as additional requirements placed on the development result.

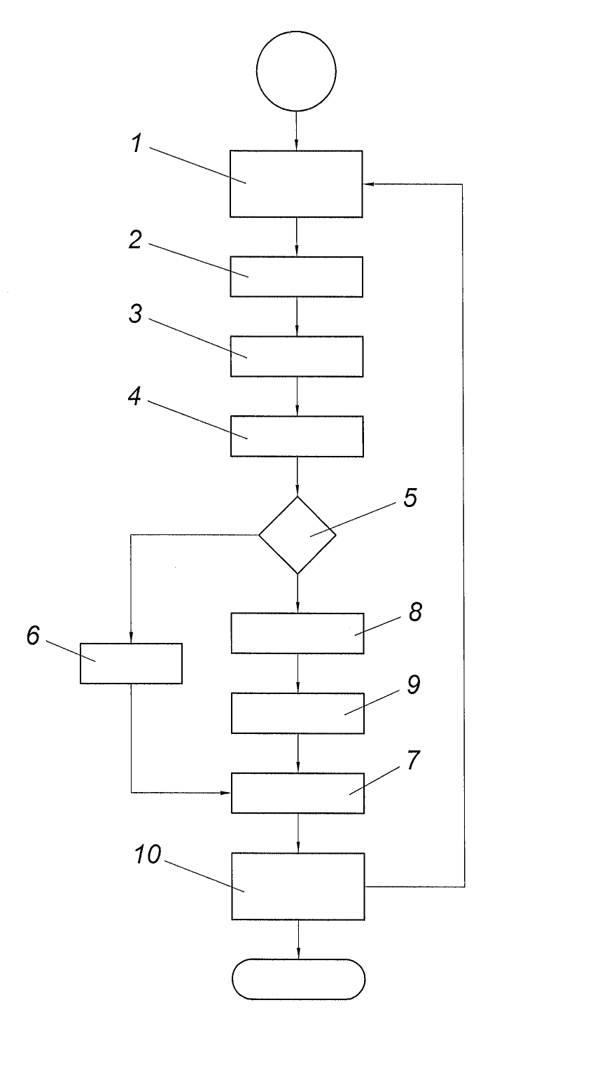

### CROSS REFERENCE TO RELATED APPLICATIONS

Applicant claims priority under 35 U.S.C. §119 of Austrian Application No. GM50014/2013 filed on Feb. 5, 2013, the disclosure of which is incorporated by reference.

### BACKGROUND OF THE INVENTION

1. Field of the Invention

The invention relates to a program logic for specifying and documenting requirements placed on a development result, wherein several individual requirements are recorded and are stored with their mutual relationships in form of a graph.

2. Description of the Related Art

Specifications and requirements placed on a development result such as the preparation of requirement specifications are conventionally recorded in form of a list of the individual requirements. Word processing programs and also specific program logics are additionally used, which allow the structured recording of the individual requirements in form of a graph. For example, the individual requirements can be saved in form of a simple tree topology, which places higher-level individual requirements in relation to subordinate detail requirements. It is disadvantageous in this respect however that the user of such a program logic is only supported in the structured preparation of the individual requirements and therefore requires in-depth technical understanding of the problem to be solved and the development result to be specified in order to fully document the individual requirements as regards their content.

### SUMMARY OF THE INVENTION

The invention is therefore based on the object of arranging a program logic of the type mentioned above in such a way that complete documentation as regards the content of all requirements placed on a development result is enabled, which occurs substantially independently from the expert knowledge of the user.

This object is achieved in accordance with the invention in such a way that templates for individual requirements associated with at least one development result are stored, a similarity value between at least one of the already recorded individual requirements and the stored requirement templates is calculated, and requirement templates are provided with a similarity value disposed in a predetermined range for individual requirements to be newly recorded, are adjusted thereto and are saved as additional requirements placed on the development result.

The invention is based on the realization that often coinciding or at least similar requirement profiles are applied to related development results, so that it is frequently possible to use previously recorded individual requirements of related development results in order to use these individual requirements or adjust them accordingly to the development result to be specified. For this reason, requirement templates can be derived and stored from the known individual requirements for different development results. From the stored catalog of requirement templates it is then only necessary to choose the individual requirements which have a respective reference to the development results to be specified, so that the chosen requirement templates can be accepted, adjusted or rejected. For this purpose, a similarity value is calculated between at least one already recorded individual requirement and the saved requirement templates, and such requirement templates are selected whose similarity value is in a predetermined range with the at least one already recorded individual requirement. On the basis of the individual requirements that were already recorded for the specification of the development result, it is thus possible to supply content proposals in form of requirement templates for the individual requirements to be recorded which the user only has to adjust to the specific development result and to store. The documentation of the requirements placed on the development result in form of requirement specifications is then prepared from the stored individual requirements.

Especially simple conditions are obtained in this connection when the similarity value is calculated on the basis of the coincidence or similarity of features associated with the recorded individual requirements on the one hand and the saved requirement templates on the other hand. These features can either be assigned manually by means of key words to the recorded individual requirements or the stored requirement templates, or they can be obtained from their textual description by means of known extraction processes. This includes for example automation-supported processes for indexing and keywording of texts.

A vector space model can be used for calculating a similarity value, in which a dimension is assigned in a vector space to each feature assigned to the recorded individual requirements and the stored requirement templates, and both the recorded individual requirements and also the stored requirement templates are modeled as vectors in this vector space. The similarity value between at least one already recorded individual requirement and several stored requirement templates corresponds to the similarity or a distance between the vectors of the requirement templates and the vectors of the recorded individual requirements.

Especially advantageous operating conditions are obtained when the stored requirement templates comprise one or several subordinate requirement templates, which are jointly adjusted to the individual requirements to be newly recorded. Accordingly, the user can be presented not only with individual requirement templates, but also with already hierarchically subdivided groups of requirement templates, which further simplifies the documentation of all requirements with complete content.

### BRIEF DESCRIPTION OF THE DRAWINGS

The subject matter of the invention is explained in closer detail by reference to the drawings, in which:

The sole FIGURE shows a program logic in accordance with the invention in a flowchart.

### DETAILED DESCRIPTION OF PREFERRED EMBODIMENTS

After the start of the program logic, it is checked in step 1 whether at least one individual requirement is already present for the development result to be specified. If this is not the case, the user is asked to input such an individual requirement. Features for calculating a similarity value with the stored requirement templates are produced in step 2 from this individual requirement, which was entered for example in form of continuous text, e.g. by manual or automated statement of keywords. The requirement templates are represented in a multidimensional vector space on the basis of their features, so that a search vector can be generated from the keyword statements determined manually or in an automated fashion, for which similar vectors are searched from the vector space in order to enable the selection of requirement templates with coinciding or similar content from the requirement catalog, as is performed in step 3.

In accordance with step 4, the selected requirement templates are displayed, wherein it needs to be distinguished in a decision step 5 whether at least one subordinate requirement template is comprised by at least one of these requirement templates. The user is offered the possibility in step 6 for the requirement templates which do not comprise any subordinate requirement templates to accept, adjust or reject these requirement templates as individual requirements. The accepted or adjusted individual requirements are then appended to the documentation in step 7 and stored.

If the requirement templates comprise sub-requirements, the master requirement is adjusted at first to the development result to be specified in step 8 before the sub-requirements linked to said master requirement are processed accordingly in step 9. The adjusted master requirement is then appended to the documentation and stored together with the process sub-requirements according to step 7.

Finally, it is decided in a selection step 10 whether further individual requirements are recorded or proposed, or whether the program logic is interrupted and the documentation is completed.

1. A program logic for specifying and documenting requirements placed on a development result, wherein several individual requirements are recorded and stored with their mutual relationships in form of a graph, wherein templates for individual requirements associated with at least one development result are stored, a similarity value between at least one of the already recorded individual requirements and the saved requirement templates is calculated, and requirement templates are provided with a similarity value disposed in a predetermined range for individual requirements to be newly recorded, are adjusted thereto and are stored as additional requirements placed on the development result.

2. A program logic according to claim 1, wherein the similarity value is calculated on the basis of the coincidence or similarity of features associated with the recorded individual requirements on the one hand and the saved requirement templates on the other hand.

3. A program logic according to claim 2, wherein a dimension is assigned in a vector space to each feature assigned to the recorded individual requirements and the stored requirement templates, and both the recorded individual requirements and also the stored requirement templates are modeled as vectors in this vector space, and the similarity value between at least one already recorded individual requirement and several stored requirement templates corresponds to a distance of the respectively associated vectors.

4. A program logic according to claim 1, wherein the stored requirement templates comprise one or several subordinate requirement templates which are jointly adjusted to the individual requirement to be newly recorded.
